(19) United States
(12) Patent Application Publication
(10) Pub. No.: US 2011/0211711 A1
(43) Pub. Date: Sep. 1, 2011

(54) Factor setting device and noise suppression apparatus

(75) Inventors: Takayuki Inoue, Hamamatsu-shi (JP); Yu Takahashi, Hamamatsu-shi (JP); Hiroshi Saruwatari, Ikoma-shi (JP); Kazunobu Kondo, Hamamatsu-shi (JP)

(73) Assignees: Yamaha Corporation; Nara Institute of Science and Technology

(21) Appl. No.: 12/932,473

(22) Filed: Feb. 25, 2011

(30) Foreign Application Priority Data
Feb. 26, 2010 (JP) 2010-041950

(51) Int. Cl. H04B 15/00

(52) U.S. Cl. 381/94.3

(57) ABSTRACT

In a noise suppression apparatus, an index setter sets an exponent K that is a positive value. A factor setter variably sets a suppression factor according to the exponent K. A noise suppressor generates an audio signal from which a noise component is suppressed through noise suppression process of suppressing a Kth power of an amplitude of the noise component at each frequency thereof in a Kth power of an amplitude of the audio signal at each frequency thereof to a degree determined according to the suppression factor set by the factor setting part. Preferably, the index setter sets the exponent K to a value less than 0.1.

### BACKGROUND OF THE INVENTION

1. Technical Field of the Invention

The present invention relates to a technology for suppressing a noise component in an audio signal.

2. Description of the Related Art

A technology for suppressing a noise component in an audio signal containing a mixed sound of a target sound component and a noise component has been suggested in the related art. For example, Non-Patent Reference 1 and Non-Patent Reference 2 suggest a technology in which the Kth power of the amplitude |Y(f)| of an audio signal, in which a noise component is suppressed, is calculated by subtracting the Kth power of the amplitude |N(f)| of each frequency of the noise component from the Kth power of the amplitude |X(f)| of each frequency of the audio signal to the degree according to a subtraction factor “a” as expressed by the following Equation (A).

|Y(f)|^{K}=|X(f)|^{K}−a|N(f)|^{K} (A)
[Non-Patent Reference 1] JAE S. Lim and Alan V. Oppenheim, “Enhancement and Bandwidth Compression of Noisy Speech”, Proceedings of the IEEE, Vol, 67, No. 12, 1979.
[Non-Patent Reference 2] Junfeng Li, et. al., “Phychoacoustically-motivated Adaptive 13-order Generalized Spectral Subtraction Based on Data-driven Optimization”, ISCA, Interspeech 2008, p. 171-174, 2008

However, in the technology of Non-Patent Reference 1 or 2, the noise component may be insufficiently or excessively suppressed depending on the set value of the exponent K since the subtraction factor a is set without consideration of the exponent K.

### SUMMARY OF THE INVENTION

Therefore, the invention has been made in view of the above circumstances, and it is an object of the invention to appropriately set a factor indicating the degree of suppression of the noise component.

In accordance with a first aspect of the invention to achieve the above object, there is provided a factor setting device comprising: a factor setting part that sets a suppression factor that indicates a degree of suppressing a Kth power of an amplitude of a noise component at each frequency thereof from a Kth power of an amplitude of an audio signal at each frequency thereof, where the exponent K is a positive value; and an index setting part that sets the exponent K, wherein the factor setting part variably sets the suppression factor according to the exponent K set by the index setting part.

Since the suppression factor is variably set according to the exponent K set by the index setting part, this configuration has an advantage in that it is possible to set a suppression factor capable of appropriately suppressing the noise component, compared to a configuration in which the suppression factor does not depend on the exponent (for example, compared to a configuration in which the suppression factor is fixed to a predetermined value or a configuration in which the suppression factor varies without consideration of the exponent K).

The value of the suppression factor for achieving a desired noise reduction rate tends to decrease as the exponent K of noise suppression decreases. Taking into consideration this tendency, it is preferable to employ a configuration in which a factor setter (i.e., the factor setting part) sets the suppression factor to a smaller value (i.e., to a value for decreasing the degree of suppression of the noise component) as the exponent K set by an index setter (i.e., the index setting part) becomes smaller.

The value of the suppression factor for achieving a desired noise reduction rate also depends on a target value of noise suppression or a magnitude distribution of the audio signal. Accordingly, from the viewpoint of more appropriately setting the suppression factor, it is preferable to employ a configuration, in which the factor setting device further comprises a noise reduction rate setting part that sets a target value of a noise reduction rate of the noise component and the factor setting part variably sets the suppression factor according to the exponent K set by the index setting part and the target value of the noise reduction rate set by the noise reduction rate setting part, or a configuration in which the factor setting device further comprises a parameter setting part that calculates, from an audio signal, a shape parameter of a probability distribution approximating a magnitude distribution of the audio signal and the factor setting part sets the suppression factor variably according to the exponent K set by the index setting part and the shape parameter calculated by the parameter setting part. Expediently, the parameter setting part calculates the shape parameter of the probability distribution approximating the magnitude distribution of the audio signal, the shape parameter representing Gaussianity of the noise components, and the factor setting part sets the suppression factor to a smaller value as the Gaussianity of the noise components increases. Expediently, the factor setting part sets the suppression factor to a smaller value as the shape parameter increases. Expediently, the factor setting part sets the suppression factor to a greater value as the target value of the noise reduction rate of the noise component increases.

The invention is also implemented as a noise suppression apparatus using the factor setting device according to each of the above aspects. That is, the noise suppression apparatus comprises: an index setting part that sets an exponent K that is a positive value; a factor setting part that variably sets a suppression factor according to the exponent K; and a noise suppression part that generates an audio signal from which a noise component is suppressed through noise suppression process of suppressing a Kth power of an amplitude of the noise component at each frequency thereof in a Kth power of an amplitude of the audio signal at each frequency thereof to a degree determined according to the suppression factor set by the factor setting part.

This configuration has an advantage in that it is possible to appropriately suppress the noise component n(t) (i.e., it is possible to avoid insufficient suppression or excessive suppression), compared to a configuration in which the suppression factor does not depend on the exponent K, since the suppression factor β is variably set according to the exponent K of noise suppression.

In the conventional noise suppression technologies that have been suggested in the related art, the exponent K to be applied to noise suppression is mostly set to 1 (in the amplitude domain) or 2 (in the power domain). However, when noise suppression is performed by setting the suppression factor so as to achieve a desired noise reduction rate while changing the exponent K of noise suppression, it is found that musical noise or cepstral distortion caused by noise suppression decreases as the exponent K decreases. Taking into consideration this finding, it is preferable to employ a configuration in which the exponent K is set to a small positive value (i.e., a value greater than zero) within a range allowable by restrictions such as calculation performance of the noise suppression apparatus (for example, within a range of values that are valid based on a predetermined floating-point value). For example, it is preferable to employ a configuration in which the exponent K is set to a value less than 0.5 (i.e., 0<K<0.5) and it is more preferable to employ a configuration in which the exponent K is set to a value less than 0.1 (i.e., 0<K<0.1). It is also preferable to employ a configuration in which the exponent K is set to a value equal to or less than, for example, 0.01, provided that the value is within a range allowable by restrictions such as calculation performance of the noise suppression apparatus. Preferably, the noise suppression part comprises an arithmetic processor for performing the noise suppression process, and the index setting part sets the exponent K to a minimum value allowable by calculation performance of the arithmetic processor.

From the viewpoint of achieving the object to set a suppression factor capable of preventing insufficient or excessive noise suppression, it is preferable to employ the first aspect in which the suppression factor is set in association with the exponent K. However, when focusing on achieving the object to reduce sound quality reduction (for example, musical noise or cepstral distortion) caused by noise suppression, it is important to employ the configuration in which the exponent K is set to a small value and it is possible to omit the configuration of the first aspect in which the suppression factor is set in association with the exponent K. That is, the noise suppression apparatus of the second aspect to achieve the object to reduce sound quality reduction caused by noise suppression comprises: a noise suppression part that generates an audio signal from which a noise component is suppressed, through noise suppression process of suppressing a Kth power of an amplitude of the noise component at each frequency thereof in a Kth power of an amplitude of the audio signal at each frequency thereof; and a parameter setting pat that sets the exponent K to a positive value less than 0.1.

It is also possible to add the condition that the exponent K be set to a small value (for example, a positive value less than 0.1) to the noise suppression apparatus or the factor setting device of the first aspect.

The noise suppression apparatus according to each of the above aspects may not only be implemented by hardware (electronic circuitry) such as a Digital Signal Processor (DSP) dedicated to processing of the audio signal but may also be implemented through cooperation of a general arithmetic processing unit such as a Central Processing Unit (CPU) with a program. A program corresponding to the factor setting device of the invention causes a computer to perform a factor setting process of setting a suppression factor that indicates a degree of suppressing a Kth power of an amplitude of a noise component at each frequency thereof from a Kth power of an amplitude of an audio signal at each frequency thereof, where the exponent K is a positive value; and an index setting process of setting the exponent K, wherein the factor setting process sets the suppression factor variably according to the exponent K set by the index setting process.

A program corresponding to the noise suppression apparatus of the first aspect of the invention causes a computer to perform an index setting process of setting an exponent K that is a positive value; a factor setting process of variably setting a suppression factor according to the exponent K; and a noise suppression process of generating an audio signal from which a noise component is suppressed by suppressing a Kth power of an amplitude of the noise component at each frequency thereof from a Kth power of an amplitude of the audio signal at each frequency thereof to a degree determined according to the suppression factor set by the factor setting process.

A program corresponding to the noise suppression apparatus of the second aspect causes a computer to perform a noise suppression process of generating an audio signal from which a noise component is suppressed by suppressing a Kth power of an amplitude of the noise component at each frequency thereof from a Kth power of an amplitude of the audio signal at each frequency thereof; and a parameter setting process of setting the exponent K to a positive value less than 0.1.

These programs achieve the same operations and advantages as those of the noise suppression apparatus according to each aspect of the invention. Each of the programs of the invention may be provided to a user through a computer readable recording medium storing the program and then installed on a computer and may also be provided from a server device to a user through distribution over a communication network and then installed on a computer.

### BRIEF DESCRIPTION OF THE DRAWINGS

FIG. 1 is a block diagram of a noise suppression apparatus according to a first embodiment;

FIGS. 2(A) through 2(D) are schematic diagrams illustrating details of noise suppression;

FIG. 3 is a block diagram of a factor setter;

FIG. 4 is a graph illustrating a relationship between an exponent K of noise suppression and a suppression factor;

FIG. 5 is a graph illustrating a relationship between an exponent K of noise suppression and Kurtosis;

FIG. 6 is a graph illustrating a relationship between an exponent K of noise suppression and cepstral distortion; and

FIG. 7 is a block diagram of a noise suppressor according to a second embodiment.

### DETAILED DESCRIPTION OF THE INVENTION

### First Embodiment

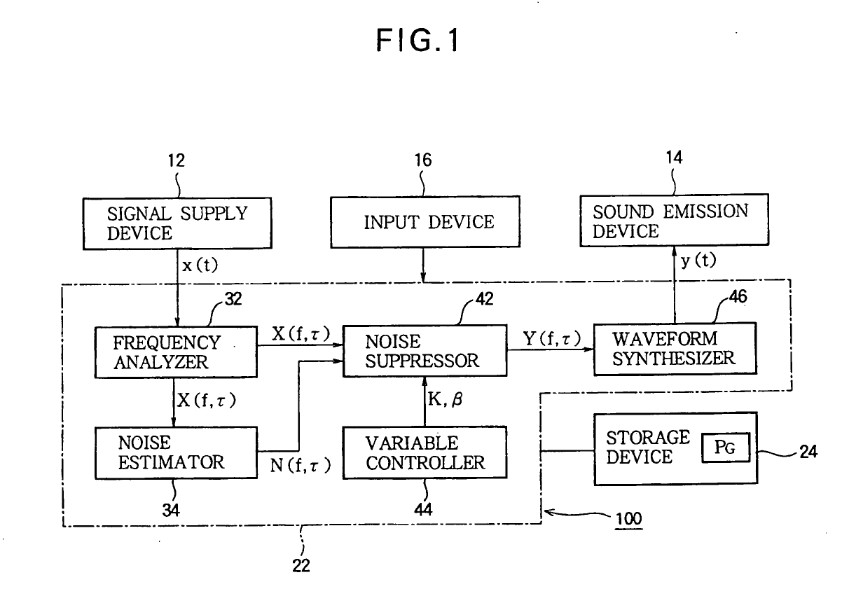

FIG. 1 is a block diagram of a noise suppression apparatus 100 according to a first embodiment of the invention. A signal supply device 12, a sound emission device 14, and an input device 16 are connected to the noise suppression apparatus 100. The signal supply device 12 provides an audio signal x(t) to the noise suppression apparatus 100. The audio signal x(t) is a time-domain signal representing a waveform of a mixed sound of a target sound component (for example, a sound such as a vocal or musical sound) s(t) and a noise component n(t) as shown in the following Equation (1).

x(t)=S(t)+n(t) (1)

A sound receiving device that receives ambient sound and generates an audio signal x(t), a playback device that receives an audio signal x(t) from a portable or internal storage medium and outputs the audio signal x(t) to the noise suppression apparatus 100, or a communication device that receives an audio signal x(t) from a communication network and outputs the audio signal x(t) to the noise suppression apparatus 100 may be employed as the signal supply device 12.

The noise suppression apparatus 100 is a signal processing device that generates an audio signal y(t) from the audio signal x(t) provided by the signal supply device 12. The audio signal y(t) is a time-domain signal representing a waveform of a sound obtained by suppressing the noise component n(t) (i.e., emphasizing the target sound component s(t)) in the audio signal x(t). The sound emission device 14 (for example, a speaker or headphone) reproduces a sound wave corresponding to the audio signal y(t) generated by the noise suppression apparatus 100. Illustration of a D/A converter that converts the audio signal y(t) from digital to analog is omitted for the sake of convenience. The input device 16 is a device (for example, a mouse or keyboard) that a user uses to input an instruction and includes, for example, a plurality of manipulators that are manipulated by the user.

As shown in FIG. 1, the noise suppression apparatus 100 is implemented through a computer system including an arithmetic processing device 22 and a storage device 24. The storage device 24 stores a variety of data used by the arithmetic processing device 22 or a program PG executed by the arithmetic processing device 22. A combination of a plurality of recording mediums or a known recording medium such as a semiconductor recording medium or a magnetic recording medium may be arbitrarily used as the storage device 24. It is also preferable to employ a configuration in which the audio signal x(t) is stored in the storage device 24 (and thus the signal supply device 12 is omitted).

The arithmetic processing device 22 implements a plurality of functions for generating the audio signal y(t) (such as a frequency analyzer 32, a noise estimator 34, a noise suppressor 42, a variable controller 44, and a waveform synthesizer 46) from the audio signal x(t) by executing the program PG stored in the storage device 24. It is also possible to employ a configuration in which each function of the arithmetic processing device 22 is distributed over a plurality of integrated circuits or a configuration in which each function is implemented through a dedicated electronic circuit (DSP).

The frequency analyzer 32 in FIG. 1 sequentially generates a spectrum (complex spectrum) X(f, τ) of the audio signal x(t) in each frame on the time axis. Here, known frequency analysis such as short-time Fourier transform may be arbitrarily employed to estimate the spectrum X(f, τ). The symbol “τ” is a variable indicating the frame and the symbol “f” is a variable indicating the frequency. A filter bank including a plurality of band pass filters having different pass bands may also be employed as the frequency analyzer 32.

The noise estimator 34 sequentially generates a spectrum (complex spectrum) N(f, τ) of the noise component n(t) included in the audio signal x(t) in each frame on the time axis. Here, a known technology may be arbitrarily employed to generate the spectrum N(f, τ) of the noise component. For example, the noise estimator 34 divides the audio signal x(t) into a target sound section or interval in which the target sound component s(t) is present and a noise section or interval in which the target sound component s(t) is not present and specifies the spectrum X(f, τ) of each frame in the noise section as the spectrum N(f, τ) of the noise component n(t). A known voice detection technology may be arbitrarily used to divide the audio signal x(t) into target sound section and noise section.

The noise suppressor 42 generates a spectrum (complex spectrum) Y(f, τ) of the audio signal y(t) by suppressing the noise component n(t) in the audio signal x(t) in the frequency domain (through spectral subtraction). The spectrum Y(f, τ) is defined by the following Equation (2).

Y(f,τ)=|Y(f,τ)|exp(jθₓ(f,τ)) (2)

A symbol “j” in Equation (2) denotes the imaginary unit and a symbol “θx(f, τ) denotes a phase angle (phase spectrum) of the audio signal x(t). The amplitude of the audio signal y(t) is calculated by suppressing the noise component n(t) (amplitude |N(f, τ)|) in the audio signal x(t) (amplitude |X(f, τ)|) as defined in the following Equations (3A) and (3B).

$$\vert Y ( f , τ ) \vert = \{ \begin{matrix}\sqrt[K]{{\vert X ( f , τ ) \vert}^{K} - β \cdot {E}_{τ} [ {\vert N ( f , τ ) \vert}^{K} ]} & ( \begin{matrix}if {\vert X ( f , τ ) \vert}^{K} - \\ β \cdot {E}_{τ} [ {\vert N ( f , τ ) \vert}^{K} ] > 0\end{matrix} ) \\ 0 & ( otherwise )\end{matrix} \qquad \begin{matrix}( 3 A ) \\ ( 3 B )\end{matrix}$$

A symbol E_{τ} in Equation (3A) denotes a time average (expected value) over a plurality of frames. A symbol β in Equation (3A) denotes a variable determining the degree of suppression of the noise component n(t), which will hereinafter be referred to as a “suppression factor”. As shown in Equation (3A), the amplitude |Y(f, τ)| of the audio signal y(t) after noise suppression is defined as the Kth root of a value obtained by subtracting the product of the suppression factor β and the Kth power of the amplitude |N(f, τ)| of the noise component n(t) from the Kth power of the amplitude |X(f, τ)| of the audio signal x(t) as shown in Equation (3A). However, when the value obtained by subtracting the product from the Kth power of the amplitude |X(f, τ)| is negative, the amplitude |Y(f, τ)| of the audio signal y(t) is set to zero as shown in Equation (3B) (through flooring). The noise suppressor 42 sequentially generates the spectrum Y(f, τ) of the audio signal y(t) in each frame of the audio signal x(t) by performing the above calculation.

The variable controller 44 of FIG. 1 variably sets the suppression factor β and the exponent (index) K applied in calculation of Equation (3A) by the noise suppressor 42. The exponent K is set within a range of positive values and the suppression factor β is set variably depending on the exponent K. Details of setting of the suppression factor β and the exponent K will be described later.

The waveform synthesizer 46 generates the audio signal y(t) of the time domain from the spectrum Y(f, τ) that the noise suppressor 42 generates in each frame. Specifically, the waveform synthesizer 46 generates the audio signal y(t) by converting the spectrum Y(f, τ) of each frame into a time-domain signal through inverse Fourier transform while connecting adjacent frames. The audio signal y(t) generated by the waveform synthesizer 46 is provided to the sound emission device 14, and the sound emission device 14 reproduces the audio signal y(t) as sound waves.

Next, the operation of noise suppression defined by Equation (3A) and Equation (3B) will be analyzed in detail. Let us focus on the power xi (xi=|X(f, τ)|², i=1, 2, . . . ) of each frequency f of the audio signal x(t) before noise suppression. Let us consider the power xi of the audio signal x(t) over a plurality of frames in the noise section in order to examine the operation of noise suppression in the noise section.

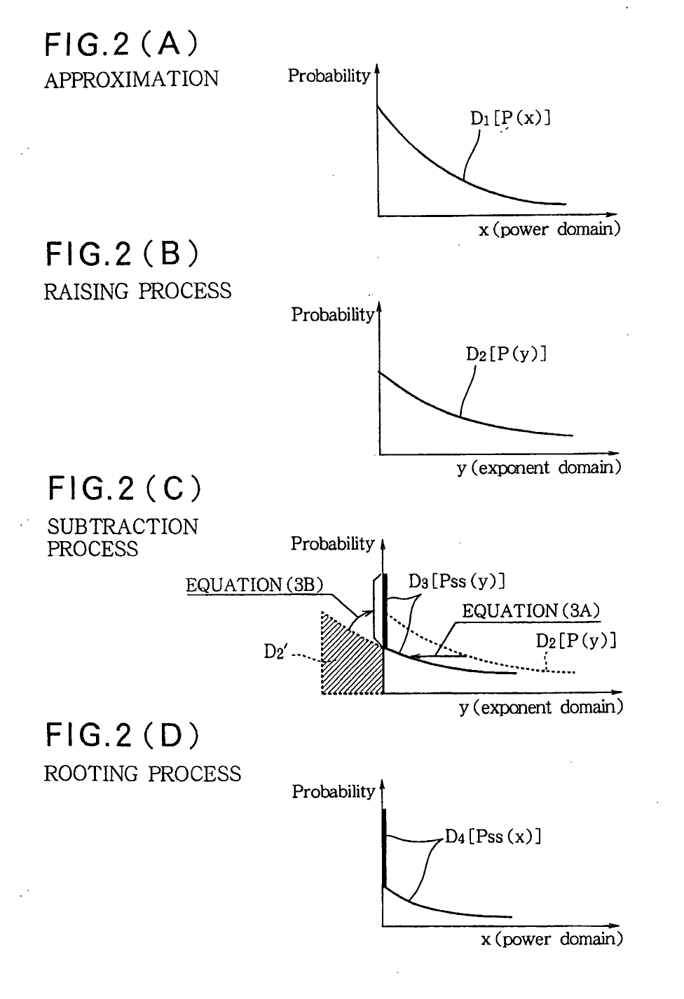

The frequence distribution of the plurality of powers xi is approximated by a probability distribution D1 whose probability variable is the power x of each frequency f of the audio signal x(t) as shown in FIG. 2(A). The probability distribution D1 of this embodiment is a Gaussian distribution defined by a probability density function (distribution function) P(x) of the following Equation (4).

$$P ( x ) = \frac{{x}^{α - 1} exp ( - \frac{x}{θ} )}{Γ ( α ) {θ}^{α}} \qquad ( 4 )$$

A symbol α in Equation (4) denotes a shape parameter expressed by the following Equations (5A) and (5B) and a symbol θ in Equation (4) denotes a scale parameter. The shape parameter α varies depending on the characteristics (or type) of the noise component n(t). For example, the value of the shape parameter α increases as Gaussianity of the noise component n(t) increases (for example, as the noise component n(t) approaches white noise). A symbol λ in Equation (5B) or (6) is the total number of the powers xi. A symbol Γ(α) in Equation (4) denotes a gamma function defined by the following Equation (7).

$$\begin{matrix}α = \frac{3 - γ + \sqrt{{( γ - 3 )}^{2} + 24 γ}}{12 γ} & ( 5 A ) \\ γ = log ( \frac{1}{λ} {\sum }_{i = 1}^{λ} xi ) - \frac{1}{λ} {\sum }_{i = 1}^{λ} log xi & ( 5 B ) \\ θ = \frac{1}{λα} {\sum }_{i = 1}^{λ} xi & ( 6 ) \\ Γ ( α ) = {\int }_{0}^{∞} {z}^{α - 1} exp ( - z ) d z & ( 7 )\end{matrix}$$

Now, let us examine the operation of Equation (3A) using the probability density function P(x) described above. Equation (3A) includes a process for raising the amplitude |X(f, τ)| of the audio signal x(t) (to the Kth power), a process for subtracting the Kth power of the amplitude |N(f, τ)| of the noise component n(t), and a process for obtaining a (Kth) root of a value obtained by subtracting the Kth power of the amplitude |N(f, τ)|. The following description focuses on how the probability density function P(x) changes in each process.

(A) Raising Process

The probability distribution D1 of the probability density function P(x) before the suppression process is changed to a probability distribution D2 of FIG. 2(B) through the raising process (to the Kth power) in Equation (3A). When a function g of the probability variable x is assumed, a probability density function P(y) (y=g(x)) representing the changed probability distribution D2 is expressed by the following Equation (8).

P(y)=P(g⁻¹(y))|J| (8)

A symbol |J| in Equation (8) denotes a Jacobian defined by the following Equation (9).

$$\vert J \vert = \vert \frac{\partial {g}^{- 1}}{\partial y} \vert \qquad ( 9 )$$

The above calculation is applied to the probability density function P(x) of the audio signal x(t). When the exponent K in Equation (3A) is replaced with a variable 2n (K=2n) while taking into consideration the fact that the probability variable x represents the power (|X(f, τ)|²), a probability variable y obtained through conversion of the probability variable x by the above function g corresponds to the nth power of the probability variable x (i.e., y=xⁿ). Thus, the Jacobian |J| is expressed by the following Equation (10).

$$\vert J \vert = \vert \frac{\partial x}{\partial y} \vert = \vert \frac{1}{{nx}^{n - 1}} \vert = \vert \frac{1}{{ny}^{( n - 1 ) / n}} \vert \qquad ( 10 )$$

Accordingly, the probability density function P(y) obtained through the raising process (to the Kth power) in Equation (3A) (i.e., the probability distribution D2 of FIG. 2(B)) is expressed by the following Equation (11).

$$P ( y ) = P ( x ) \vert J \vert = \frac{{y}^{α / n - 1} exp ( - {y}^{1 / n} / θ )}{n Γ ( α ) {θ}^{α}} \qquad ( 11 )$$

Next, let us examine an expected value E[y] (Eτ[|N(f, τ)|^{K}]) obtained through the raising process (to the Kth power) of the amplitude |N(f, τ)| of the noise component n(t) in Equation (3A). The expected value E[y] is expressed by the following Equation (12) using the above Equation (11).

$$\begin{matrix}E [ y ] = {\int }_{0}^{∞} yP ( y ) d y \\ = {\int }_{0}^{∞} \frac{{y}^{α / n} exp ( - {y}^{1 / n} / θ )}{n Γ ( α ) {θ}^{α}} d y\end{matrix} \qquad ( 12 )$$

The following Equation (13) is derived by performing integration by substitution using a variable y^{1/n}/θ in Equation (12) as a basic variable u (dy=nθ(θu)ⁿ⁻¹du). The following Equation (14) is derived by applying Equation (7) to Equation (13).

$$\begin{matrix}E [ y ] = \frac{{θ}^{n}}{Γ ( α )} {\int }_{0}^{∞} {u}^{α + n - 1} exp ( - u ) d u & ( 13 ) \\ E [ y ] = \frac{{θ}^{n} Γ ( α + n )}{Γ ( α )} & ( 14 )\end{matrix}$$

(B) Subtraction Process

The probability distribution D2 of the Probability density function P(y) obtained through the raising process is changed to a probability distribution D3 of FIG. 2(C) through the subtraction process of Equations (3A) and (3B). As denoted by an arrow in FIG. 2(C), the probability distribution D3 has a shape obtained by translating the probability distribution D2 to the negative side of the probability variable y by the extent corresponding to the product of the expected value E[y] of the noise component n(t) and the suppression factor β (see Equation (3A)) and adding the sum of the probabilities (frequencies) of the probability variable y that has become negative after the movement of the probability distribution D2 to the probability of the probability variable y being zero (see Equation (3B)). Accordingly, the probability density function Pss(y) of the probability distribution D3 is expressed by the following Equations (15A) and (15B).

$$Pss ( y ) = \{ \begin{matrix}\frac{1}{n {θ}^{α} Γ ( α )} {( y + β c )}^{α / n - 1} exp ( - {( y + β c )}^{1 / n} / θ ) & ( y > 0 ) \\ \frac{1}{n {θ}^{α} Γ ( α )} {\int }_{0}^{β c} {y}^{α / n - 1} exp ( - {y}^{1 / n} / θ ) d y & ( y = 0 ) ( 15 B )\end{matrix} \qquad ( 15 A )$$

A symbol “c” in Equations (15A) and (15B) denotes the expected value E [y] in Equation (14) (c=E[y]=θⁿΓ(α+n)/Γ(α)). Equation (15A) corresponds to an equation obtained by replacing the probability variable y in Equation (11) with a variable (y+βc)(i.e., corresponds to a probability density function of a probability distribution D2′ to which the probability distribution D2 of Equation (11) is translated to the negative side of the probability variable y by a shift βc). On the other hand, Equation (15B) corresponds to a process for adding the probability of the probability variable y that has become negative through the subtraction process of Equation (3A) (i.e., the sum of the probabilities of a shaded part in FIG. 2(C)) to the probability of the probability variable being zero in the translated probability distribution D2′ (i.e., corresponds to the flooring process of Equation (3B)).

(C) Rooting Process

The probability density function Pss(y) of Equations (15A) and (15B) are converted to a probability density function Pss(x) defined by a probability variable corresponding to power through the rooting process of Equation (3A). The probability density function Pss(x) obtained through the rooting process is expressed by the following Equations (16A) and (16B) obtained by replacing the variable y in Equations (15A) and (15B) with a variable x (x=|y(f, τ)²|) in the same method as in the raising process.

$$Pss ( x ) = \{ \begin{matrix}\frac{1}{ {θ}^{α} Γ ( α )} {{x}^{n - 1} ( x + β c )}^{α / n - 1} exp ( - {( x + β c )}^{1 / n} / θ ) & ( x > 0 ) \\ \frac{1}{ {θ}^{α} Γ ( α )} {\int }_{0}^{β c} {x}^{α - 1} exp ( - x / θ ) d x & ( x = 0 ) ( 16 B )\end{matrix} \qquad ( 16 A )$$

The mth moment μm about the origin of the probability density function Pss(x) of Equation (16A) is expressed by the following Equation (17) which is obtained by integration of substitution using a variable (x+βc)^{1/n}/θ in Equation (16A) as a basic variable v.

$${μ}_{m} = E [ {x}^{m} ] = \frac{{θ}^{m}}{Γ ( α )} {\int }_{{B}^{1 / n}}^{∞} {( {v}^{n} - B )}^{m / n} {v}^{α - 1} exp ( - v ) d v \\ B = \frac{βΓ ( α + n )}{Γ ( α )} \qquad ( 17 )$$

The following Equation (18) representing the mth moment is analytically derived by setting the condition that a variable m/n is a natural number in order to perform polynomial expansion of the variable (vⁿ−B)^{m/n} in Equation (17) and then expanding Equation (17) under the condition.

$$\begin{matrix}{μ}_{m} = \frac{{θ}^{m}}{Γ ( α )} {\int }_{{B}^{1 / n}}^{∞} {( {v}^{n} - B )}^{m / n} {v}^{α - 1} exp ( - v ) d v \\ = \frac{{θ}^{m}}{Γ ( α )} {\sum }_{l = 0}^{m / n} {( - B )}^{l} \frac{Γ ( m / n + 1 )}{Γ ( l + 1 ) Γ ( m / n - l + 1 )} Γ ( α + m - nl , {B}^{1 / n} )\end{matrix} \qquad ( 18 )$$

A symbol Γ(α, w) in Equation (18) denotes an incomplete gamma function of the second kind defined by the following Equation (19).

Γ(α,w)=∫_{w}^{∞}z−^{α-1}exp(−z)dz (19)

The spectrum Y(f, τ) that the noise suppressor 42 generates through noise suppression (spectral subtraction) of Equation (3A) includes high-magnitude components (acnodes) that are distributed over the time axis and the frequency axis, causing artificial and harsh musical noise. Taking into consideration that noise suppression increases non-Gaussianity, the Kurtosis of the frequence distribution (probability density function) of signal magnitudes is used as a quantitative index of the amount of musical noise caused by noise suppression. That is, it can be estimated that the obviousness of musical noise increases as Kurtosis change through noise suppression increases. In the following description, the ratio κ of the Kurtosis kB after noise suppression to the Kurtosis kA before noise suppression, which will hereinafter be referred to as a “Kurtosis ratio”, is used as an index of the amount of musical noise (i.e., κ=kB/kA). Details of the relation between Kurtosis and musical noise are described in “Relationship between logarithmic Kurtosis ratio and degree of musical noise generation on spectral subtraction”, UEMURA Yoshihisa and four others, Technical report of the Institute of Electronics, Information and Communication Engineers (IEICE), Engineering Acoustics (EA)108(143), p. 43-48, 2008, Jul. 11.

The following Equation (20) defining the Kurtosis kB after noise suppression is derived using the mth moment of Equation (18).

$$kB = \frac{{μ}_{4}}{{μ}_{2}^{2}} = Γ ( α ) \frac{M ( α , β , 4 / n )}{{M ( α , β , 2 / n )}^{2}} \qquad ( 20 )$$

A function M(α, β, m/n) of Equation (20) is defined by the following Equation (21).

$$M ( α , β , m / n ) = {\sum }_{l = 0}^{m / n} {( - B )}^{l} \frac{Γ ( m / n + 1 )}{Λ ( l + 1 ) Λ ( m / n - l + 1 )} Γ ( α + m - nl , {B}^{1 / n} ) \qquad ( 21 )$$

The Kurtosis kB when the suppression factor β in Equation (20) is set to zero is specified as the Kurtosis kA before noise suppression. Then, the ratio of the Kurtosis kB to the Kurtosis kA is defined as the Kurtosis ratio κ (κ=kB/kA). Since the range of the sum (0˜m/n) of Equation (21) which defines the variable M(α, β, m/n) includes zero)((−B)⁰) although the variable B when the suppression factor β is zero is zero, the Kurtosis kA calculated by setting the suppression factor β to zero has a valid value (i.e., a value other than zero) if the 0th power of zero ((−B)⁰=0⁰) is defined as “1”.

Now, let us examine a noise reduction rate (NRR) which is an index of the performance of noise suppression by the noise suppressor 42. The noise reduction rate NRR is the difference between the signal to noise ratio (SNR) after noise suppression and the SNR before noise suppression and is defined by the following Equation (22).

$$N R R = 10 {log}_{10} \frac{\sum {s}_{out}^{2} / \sum {n}_{out}^{2}}{\sum {s}_{in}^{2} / \sum {n}_{in}^{2}} \qquad ( 22 )$$

A symbol “s” in Equation (22) denotes a signal component, which is a component to be emphasized, and a symbol “n” denotes a noise component. The subscript “in” denotes “before noise suppression” and the subscript “out” denotes “after noise suppression”. That is, a denominator of Equation (22) corresponds to the SNR before noise suppression and a numerator of Equation (22) corresponds to the SNR after noise suppression.

Assuming that the amount of subtraction of the noise component by noise suppression is sufficiently greater than the amount of subtraction of the signal component by noise suppression, Equation (22) approximates to the following Equation (23) since the signal component-before noise suppression and the signal component after noise suppression are considered equal (Σsₒᵤₜ²≈Σsᵢₙ²).

$$N R R = 10 {log}_{10} \frac{\sum {n}_{in}^{2}}{\sum {n}_{out}^{2}} \qquad ( 23 )$$

A variable Σnᵢₙ²/Σnₒᵤₜ² in Equation (23) is expressed as the ratio between an expected value of the noise component before noise suppression and an expected value of the noise component after noise suppression. The expected value of the noise component before noise suppression is derived by setting the variable β to zero in a definition equation of the 1st moment μl obtained by setting the variable m in Equation (18) to “1” and the expected value of the noise component after noise suppression is derived by assuming that the variable β is a non-zero value. The ratio between the expected values is rearranged to derive the following Equation (24), which defines the noise reduction rate NRR according to the shape parameter α, the suppression factor β, and the exponent n (n K/2). Equation (24) is derived using both a relation that an incomplete gamma function of the second kind Γ(α, w) of Equation (18) when the suppression factor β is set to zero is equal to the gamma function and a relation that a gamma function Γ(1) with the shape parameter α being set to 1 is 1.

$$N R R = 10 {log}_{10} \frac{Γ ( α + 1 )}{M ( α , β , 1 / n )} \qquad ( 24 )$$

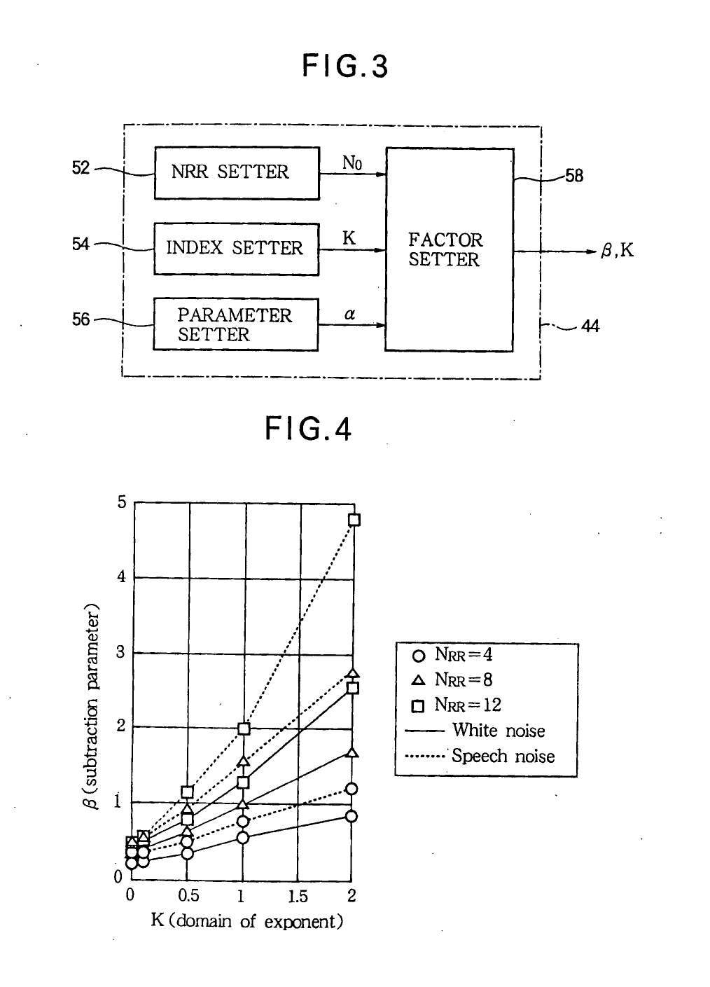

The variable controller 44 of FIG. 1 variably sets the suppression factor β using the relation of Equation (24). FIG. 3 is a block diagram of the variable controller 44. As shown in FIG. 3, the variable controller 44 includes a noise reduction rate setter 52, an index setter 54, a parameter setter 56, and a factor setter 58. The noise reduction rate setter 52 sets a target value N0 of the noise reduction rate NRR. For example, the noise reduction rate setter 52 variably sets the target value N0 according to an instruction that the user has input through the input device 16. The user makes an instruction to set the target value N0, for example, according to noise suppression performance required for the intended use of the noise suppression apparatus 100.

The index setter 54 of FIG. 3 variably sets the exponent (or index) K (K=2n) applied to noise suppression. For example, the index setter 54 variably sets the exponent K according to an instruction that the user has input through the input device 16. The user may make an instruction to set an arbitrary positive value as the exponent K. A detailed value of the exponent K is described later.

The parameter setter 56 sets the shape parameter α of the probability distribution D1 (probability density function P(x)) that approximates the frequence distribution of the power xi of the audio signal x(t) before noise suppression. Specifically, the parameter setter 56 calculates the shape parameter α by applying a plurality of powers xi, which are specified from the audio signal x(t) (spectrum X(f, τ)) in each frequency f for each of a plurality of frames included in the noise section, to Equations (5A) and (5B).

The factor setter 58 of FIG. 3 variably sets the suppression factor β according to (the target value N0 of) the noise reduction rate NRR set by the noise reduction rate setter 52, the exponent K set by the index setter 54, and the shape parameter α calculated by the parameter setter 56. An iterative method using Equation (24) is used to calculate the suppression factor β. Specifically, the factor setter 58 calculates a plurality of noise reduction rates NRR corresponding to different suppression factors β by sequentially performing the calculation of Equation (24) using the exponent K set by the index setter 54 and the shape parameter α calculated by the parameter setter 56 while successively changing the (candidate) value of the suppression factor β within a predetermined range and then selects a suppression factor β at which a noise reduction rate NRR sufficiently close to the target value N0 set by the noise reduction rate setter 52 is calculated as an established suppression factor β which is actually applied to noise suppression. The suppression factor β set by the factor setter 58 and the exponent K set by the index setter 54 are applied to noise suppression (using Equation (3A)) by the noise suppressor 42.

FIG. 4 is a graph illustrating the relationship between the noise reduction rate NRR, the exponent K (K=2n), the shape parameter α, and the suppression factor β. The suppression factor β is calculated through calculation of Equation (24) such that the noise reduction rate NRR is equal to the target value (NRR=4, 8, 12[dB]) for each changed value of the exponent K (K=0.002, 0.01, 0.5, 1, 2) and the shape parameter α and is illustrated on the vertical axis of FIG. 4. The horizontal axis of FIG. 4 represents the exponent K (K=0.002, 0.01, 0.5, 1, 2). Solid lines represent relations between the exponent K and the suppression factor β when the shape parameter α of the noise component n(t) is large (i.e., in the case of white noise having high Gaussianity) and dashed lines represent relations between the exponent K and the suppression factor β when the shape parameter α of the noise component n(t) is small (i.e., in the case of speech noise having low Gaussianity).

As is understood from FIG. 4, first, the factor setter 58 sets the suppression factor β to a higher value as the target value N0 of the noise reduction rate NRR set by the noise reduction rate setter 52 increases (i.e., as the required noise suppression performance increases). Second, the factor setter 58 sets the suppression factor β to a lower value as the exponent K set by the index setter 54 decreases. Third, the factor setter 58 sets the suppression factor β to a lower value as the shape parameter a set by the parameter setter 56 increases (i.e., as the Gaussianity of the noise component n(t) increases).

The above embodiment has an advantage in that it is possible to appropriately suppress the noise component n(t) (so as to avoid insufficient suppression or excessive suppression), compared to a configuration in which the suppression factor β does not depend on the exponent K (for example, a configuration in which the suppression factor β is fixed to a specific value or a configuration in which the suppression factor β varies without consideration of the exponent K) since the suppression factor β is variably set according to the exponent K of noise suppression.

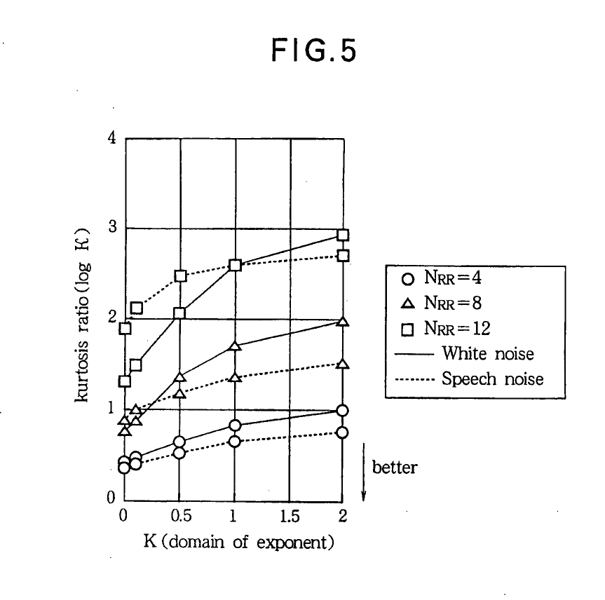

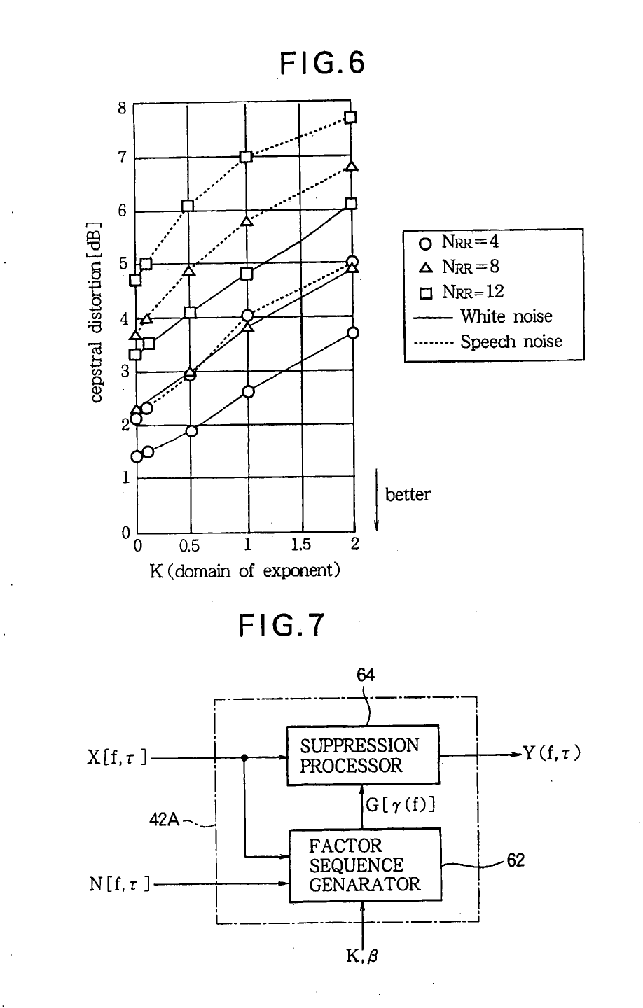

Next, let us examine suitable values of the exponent K. FIG. 5 is a graph illustrating the relationship between the exponent K and the Kurtosis ratio κ. In FIG. 5, the vertical axis represents the logarithm (log κ) of the Kurtosis ratio κ (κ=kB/kA) calculated from the above Equation (20). A smaller Kurtosis ratio κ, which is at the lower side in FIG. 5, indicates that noise suppression causes less musical noise. FIG. 6 is a graph illustrating the relationship between the exponent K and the cepstral distortion. The cepstral distortion is an index of a change of the cepstrum through noise suppression (i.e., the difference between the target sound component s(t) and the audio signal y(t)). A smaller cepstral distortion, which is at the lower side in FIG. 6, indicates that noise suppression causes a smaller change in the spectral envelope (i.e., indicates that the spectral envelope of the target sound component s(t) is sufficiently emphasized). Similar to FIG. 4, the characteristics of each of a plurality of cases in which the noise reduction rate NRR (target value N0) and the shape parameter α are changed are also illustrated in FIGS. 5 and 6.

As is understood from FIG. 5, the value of the Kurtosis ratio κ decreases as the exponent K decreases, regardless of the shape parameter α (the type of the noise component n(t)) and the noise reduction rate NRR. That is, musical noise after noise suppression decreases as the exponent K decreases. In addition, the degree of change in the Kurtosis ratio κ with respect to the exponent K increases as the noise reduction rate NRR increases. On the other hand, as is understood from FIG. 6, the value of the cepstral distortion decreases as the exponent K decreases, regardless of the shape parameter α and the noise reduction rate NRR. That is, the spectral envelope of the target sound component s(t) is more correctly maintained in the audio signal y(t) as the exponent K decreases.

It can also be seen from FIGS. 5 and 6 that it is possible to more appropriately generate the audio signal y(t) as the exponent K is set to a smaller value from the viewpoint of both the amount of generated musical noise and the reproducibility of the target sound component s(t) (i.e., the extent of maintenance of the signal) as described above. Accordingly, ideally, the exponent K is set to the minimum value in a range allowable by the calculation performance of the arithmetic processing device 22 (for example, within a range of values that are valid based on floating-point values that can be computed by the arithmetic processing device 22 without causing underflow). That is, the user instructs, through the input device 16, the index setter 54 to set the minimum exponent K, for example, specified based on calculation performance of the arithmetic processing device 22.

Specifically, it can be understood that it is possible to generate an audio signal y(t) with higher sound quality than a general noise suppression technology, which sets the exponent K to 2 (in the power domain) or 1 (in the amplitude domain), by setting the exponent K to a value equal to or less than 0.5 and it is also possible to improve the sound quality of the audio signal y(t) (i.e., to reduce musical noise or cepstral distortion) by further reducing the exponent K. For example, the exponent K is preferably set to a positive value less than 0.1 within a range of values not restricted by calculation performance of the arithmetic processing device 22 and is more preferably set to a positive value (for example, 0.02) equal to or less than 0.01.

By the way, prior papers have observed that the exponent K of 0.1 degrades the sound quality. The present invention reveals that the exponent K less than 0.1 is advantageous. The inventors herein refer to the following prior papers “Psychoacoustically-motivated Adaptive β-order Generalized Spectral Subtraction Based on Data-driven Optimization” Junfeng Li, Hui Jiang, Masato Akagi, 2008 ISCA, September 22-26, Brisbane Australia, and “A Parametric Formulation of the Generalized Spectral Subtraction Method”, Boh Lim Sim, Yit Chow Tong, Joseph S. Chang, and Chin Than Tan, IEEE TRANSACTIONS ON SPEECH AND AUDIO PROCESSING, VOL. 6, NO. 4, JULY 1998.

The first paper states as follows: β (equivalent to exponent K)=0.1 yields greatly reduced SNR results because it introduces severe speech distortion due to the too small value of β (i.e., 0.1). The highest SNR algorithm indicates high noise reduction ability corresponding to high speech intelligibility in some sense. This might be attributed to the use of low gains in speech-absence periods due to the low values of the spectral order β. Concerning the results of LSD, all tested algorithms decrease the LSD in all conditions, except for the SS algorithm with β=0.1 that markedly increases LSD (i.e., high speech distortion and low intelligibility).

The second paper states as follows: α is the generalized power exponent for the spectrum; outside this range of duration, degradation of the speech quality was sometimes observed. In this case, the degradation can be reduced by raising the spectral gain floor α to more than 0.20.

### B: Second Embodiment

The second embodiment of the invention will now be described. In the first embodiment, the amplitude |Y(f, τ)| of the audio signal y(t) is calculated by subtracting the noise component n(t) (amplitude |N(f, τ)|) from the audio signal x(t) (the amplitude |X(f, τ)|). However, the calculation for generating the audio signal y(t) is not limited to subtraction (spectral subtraction). In the second embodiment, the amplitude |Y(f, τ)| of the audio signal y(t) is calculated by multiplying the amplitude |X(f, τ)| of the audio signal x(t) by a predetermined factor (gain). Elements of the following examples having the same operations and functions as the first embodiment will be described using the same reference numerals as described above and a detailed description thereof will be omitted as appropriate.

In the second embodiment, the noise suppressor 42 of the first embodiment is replaced with a noise suppressor 42A in FIG. 7. The noise suppressor 42A of the second embodiment includes a factor sequence generator 62 and a suppression processor 64 as shown in FIG. 7. The factor sequence generator 62 generates a factor sequence G used for noise suppression. The factor sequence G is a sequence of factor values (spectral gains) γ(f) corresponding to different frequencies f. The factor value γ(f) of a frequency f is a gain for the component of the frequency f of the audio signal x(t) and is calculated for each frequency f, for example, through calculation of the following Equation (25).

$$γ ( f ) = \frac{max ( \sqrt[K]{{\vert X ( f , τ ) \vert}^{K} - β \cdot {E}_{τ} [ {\vert N ( f , τ ) \vert}^{K} ]} , 0 )}{\vert X ( f , τ ) \vert} \qquad ( 25 )$$

A symbol “max(a, b)” in Equation (25) denotes the large of a value “a” and a value “b”. That is, the numerator of Equation (25) is the same as Equations (3A) and (3B). Division by the amplitude |X(f, τ)| in Equation (25) is a calculation for normalizing the factor value γ(f) to a value equal to or less than 1 (0≦γ(f)≦1). The suppression factor β and the exponent K in Equation (25) are variably set by the variable controller 44, similar to the first embodiment.

The suppression processor 64 in FIG. 7 calculates the amplitude |Y(f, τ)| of the audio signal y(t) by multiplying the amplitude |X(f, τ)| of the audio signal x(t) by each factor value γ(f) of the factor sequence G generated by the factor sequence generator 62 as shown in the following Equation (26).

|Y(f,τ)|=γ(f)|X(f,τ)| (26)

As is understood from Equation (25), the factor value γ(f) of a frequency f is set to a smaller value as the amplitude |N(f, τ)| of the noise component n(t) in the audio signal x(t) at the frequency f increases. Accordingly, an audio signal y(t) in which the amplitude |X(f, τ)| is more suppressed (i.e., an audio signal in which the noise component n(t) is more suppressed, similar to the first embodiment) is generated at a frequency f at which the amplitude |N(f, τ)| of the noise component n(t) is higher in the audio signal x(t).

This embodiment also achieves the same advantages as those of the first embodiment. As is understood from the examples of the first and second embodiments, the suppression factor β, the exponent K, or the like set by the variable controller 44 are not limited to the factors directly used for noise suppression (Equation (3A) of the first embodiment) and can also be applied to calculation of values (the factor sequence G in the second embodiment) used for noise suppression.

### C: Modifications

Various modifications can be made to each of the above embodiments. The following are specific examples of such modifications. It is also possible to appropriately combine two or more examples arbitrarily selected from the following examples.

(1) Modification 1

Each of the variable setting methods may be appropriately changed. For example, although the exponent K is set according to an instruction from the user in the above embodiments, it is possible to employ a configuration in which the index setter 54 automatically sets the exponent K (without requiring an instruction from the user). For example, the index setter 54 sets the exponent K according to calculation performance of the arithmetic processing device 22 (for example, the minimum exponent K within a range allowable by restrictions of calculation performance such as floating-point values). It is also preferable to employ a configuration in which the index setter 54 sets the exponent K to a positive value less than 0.1 (more preferably, less than 0.01), regardless of the method of setting the exponent K, similar to the first embodiment. In addition, although the shape parameter α and the target value N0 of the noise reduction rate NRR are variably set in each of the above embodiments, it is possible to employ a configuration in which at least one of the shape parameter α and the target value N0 is fixed to a predetermined value. Accordingly, the parameter setter 56 or the noise reduction rate setter 52 may be omitted.

(2) Modification 2

Although the factor setter 58 calculates the suppression factor β by performing the calculation of Equation (24) in each of the above embodiments, the method of specifying the suppression factor β according to the exponent K (in addition to the shape parameter α or the noise reduction rate NRR) may be appropriately changed. For example, it is possible to employ a configuration in which a table, in which suppression factors β are associated with combinations of the values of the exponent K, the shape parameter α, and the target value N0 of the noise reduction rate NRR, is stored in the storage device 24, and the factor setter 58 searches the table for a suppression factor β corresponding to input values of the variables (K, α, N0) and provides the retrieved suppression factor β to the noise suppressor 42.

(3) Modification 3

Although the amplitude |N(f, τ)| of the noise component n(t) is time-averaged after being raised to the Kth power (i.e., ET [|N(f, τ)|^{K}]) in noise suppression of the first embodiment (using Equation (3A)) and calculation of the factor sequence G of the second embodiment (using Equation (25)), it is possible to employ a configuration in which the amplitude |N(f, τ)| of the noise component n(t) is time-averaged and then raised to the Kth power (i.e., {Eτ[|N(f, τ)|]}^{K}). That is, the amplitude of the noise component n(t) that is to be raised to the exponent K may be either of the amplitude |N(f, τ)| before time averaging or the amplitude Eτ[|N(f, τ)|] after time averaging. It is also possible to employ a configuration in which time averaging of the noise component n(t) is omitted (for example, a configuration in which the Kth power of the amplitude |N(f, τ)| of one frame is subtracted from the amplitude |X(f, τ)| according to the suppression factor β).

(4) Modification 4

Although the amplitude |Y(f, τ)| of the audio signal y(t) is set to zero (through a flooring process) when a value obtained by subtracting the noise component n(t) from the audio signal x(t) (|X(f, τ)|K−suppression factor βEτ[|M(f, τ)|^{K}]) is negative in each of the above embodiments, the value applied to the flooring process is not limited to zero. For example, it is possible to employ a configuration in which the amplitude |Y(f, τ)| of a frequency f, at which a value obtained by subtracting the noise component n(t) from the audio signal x(t) is negative, is set to a value based on the amplitude |X(f, τ)| or the amplitude |N(f, τ)| (for example, set to a value a1|X(f, τ)| or a value a2|N(f, τ)|, each of the factors a1 and a2 being set to a predetermined value).

(5) Modification 5

Although the noise suppression apparatus 100 including the variable controller 44 and the noise suppressor 42 is illustrated in each of the above embodiments, the invention may also be specified as a factor setting device that sets the suppression factor β applied to noise suppression. Here, whether the factor setting device is configured integrally with the noise suppressor 42 (i.e., the noise suppression apparatus 100 is configured as described above in each of the embodiments) or is configured separately from the noise suppressor 42 (i.e., the noise suppression apparatus) does not matter in the invention.

What is claimed is:

1. A factor setting device comprising:
a factor setting part that sets a suppression factor that indicates a degree of suppressing a Kth power of an amplitude of a noise component at each frequency thereof from a Kth power of an amplitude of an audio signal at each frequency thereof, where the exponent K is a positive value; and
an index setting part that sets the exponent K,
wherein the factor setting part sets the suppression factor variably according to the exponent K set by the index setting part.

2. The factor setting device according to claim 1, wherein the factor setting part sets the suppression factor to a smaller value as the exponent K set by the index setting part decreases.

3. The factor setting device according to claim 1, further comprising:
a noise reduction rate setting part that sets a target value of a noise reduction rate of the noise component; and
a parameter setting part that calculates, from the audio signal, a shape parameter of a probability distribution approximating a magnitude distribution of the audio signal,
wherein the factor setting part sets the suppression factor according to the exponent K set by the index setting part, the target value of the noise reduction rate set by the noise reduction rate setting part, and the shape parameter calculated by the parameter setting part.

4. The factor setting device according to claim 3, wherein the parameter setting part calculates the shape parameter of the probability distribution approximating the magnitude distribution of the audio signal, the shape parameter representing Gaussianity of the noise components, and wherein the factor setting part sets the suppression factor to a smaller value as the Gaussianity of the noise components increases.

5. The factor setting device according to claim 3, wherein the factor setting part sets the suppression factor to a smaller value as the shape parameter increases.

6. The factor setting device according to claim 3, wherein the factor setting part sets the suppression factor to a greater value as the target value of the noise reduction rate of the noise component increases.

7. The factor setting device according to claim 1, wherein the index setting part sets the exponent K to a value less than 0.1.

8. The factor setting device according to claim 1, further comprising an arithmetic processor, wherein the index setting part sets the exponent K to a minimum value allowable by calculation performance of the arithmetic processor.

9. A noise suppression apparatus comprising:
an index setting part that sets an exponent K that is a positive value;
a factor setting part that sets a suppression factor variably according to the exponent K; and
a noise suppression part that generates an audio signal from which a noise component is suppressed through noise suppression process of suppressing a Kth power of an amplitude of the noise component at each frequency thereof in a Kth power of an amplitude of the audio signal at each frequency thereof to a degree determined according to the suppression factor set by the factor setting part.

10. The noise suppression apparatus according to claim 9, wherein the factor setting part sets the suppression factor to a smaller value as the exponent K set by the index setting part decreases.

11. The noise suppression apparatus according to claim 9, further comprising a parameter setting part that calculates Gaussianity of noise components, wherein the factor setting part sets the suppression factor to a smaller value as the Gaussianity of the noise components increases.

12. The noise suppression apparatus according to claim 9, wherein the noise suppression part comprises an arithmetic processor for performing the noise suppression process, and the index setting part sets the exponent K to a minimum value allowable by calculation performance of the arithmetic processor.

13. A noise suppression apparatus comprising:
a noise suppression part that generates an audio signal from which a noise component is suppressed, through noise suppression process of suppressing a Kth power of an amplitude of the noise component at each frequency thereof in a Kth power of an amplitude of the audio signal at each frequency thereof; and
a parameter setting part that sets the exponent K to a positive value less than 0.1.

14. The noise suppression apparatus according to claim 13, further comprising a factor setting part that sets a suppression factor that indicates a degree of suppressing the Kth power of the amplitude of the noise component at each frequency thereof from the Kth power of the amplitude of the audio signal at each frequency thereof, wherein the factor setting part sets the suppression factor to a smaller value as the exponent K set by the index setting part decreases.

15. The noise suppression apparatus according to claim 14, further comprising a parameter setting part that calculates Gaussianity of noise components, wherein the factor setting part sets the suppression factor to a smaller value as the Gaussianity of the noise components increases.

16. The noise suppression apparatus according to claim 14, wherein the noise suppression part comprises an arithmetic processor for performing the noise suppression process, and wherein the factor setting part sets the suppression factor to a minimum value allowable by calculation performance of the arithmetic processor.

17. A machine readable storage medium for use in a computer, the medium containing program instructions executable by the computer to perform:
a factor setting process of setting a suppression factor that indicates a degree of suppressing a Kth power of an amplitude of a noise component at each frequency thereof from a Kth power of an amplitude of an audio signal at each frequency thereof, where the exponent K is a positive value; and
an index setting process of setting the exponent K,
wherein the factor setting process sets the suppression factor variably according to the exponent K set by the index setting process.

18. A machine readable storage medium for use in a computer, the medium containing program instructions executable by the computer to perform:
an index setting process of setting an exponent K that is a positive value;
a factor setting process of setting a suppression factor variably according to the exponent K; and
a noise suppression process of generating an audio signal from which a noise component is suppressed by suppressing a Kth power of an amplitude of the noise component at each frequency thereof from a Kth power of an amplitude of the audio signal at each frequency thereof to a degree determined according to the suppression factor set by the factor setting process.

19. A machine readable storage medium for use in a computer, the medium containing program instructions executable by the computer to perform:
a noise suppression process of generating an audio signal from which a noise component is suppressed by suppressing a Kth power of an amplitude of the noise component at each frequency thereof from a Kth power of an amplitude of the audio signal at each frequency thereof; and
a parameter setting process of setting the exponent K to a positive value less than 0.1.
